(19) United States
(12) Patent Application Publication
(10) Pub. No.: US 2008/0007743 A1
(43) Pub. Date: Jan. 10, 2008

(54) PRINTING APPARATUS, PRINTING SYSTEM AND PRINTING METHOD

(75) Inventor: Hong-rok WOO, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/767,577

(22) Filed: Jun. 25, 2007

(30) Foreign Application Priority Data
Jul. 5, 2006 (KR) 2006-63074

(51) Int. Cl. G06K 15/02

(52) U.S. Cl. 358/1.2

(57) ABSTRACT

A printing apparatus includes: a communications unit which communicates with a host machine; a printing unit which prints an image on a printable medium; and a controller which alters a printing reference for an image with respect to the printable medium using size information of the image to be printed, and size information of the printable medium on which the image is printed. As a result, a user is able to properly print the part of an image which he or she wishes to print, by altering a printing reference of the image.

### CROSS-REFERENCE TO RELATED APPLICATIONS

This application claims all benefits accruing under 35 U.S.C. §119 from Korean Patent Application No. 2006-63074, filed on Jul. 5, 2006, in the Korean Intellectual Property Office, the disclosure of which is incorporated herein by reference.

### BACKGROUND OF THE INVENTION

1. Field of the Invention

The present invention relates to a printing apparatus, and more particularly, to a printing apparatus, a printing system, and a printing method which can enable a user to print selected portion or an entire image on a screen.

2. Related Art

A printing apparatus, such as a printer, a photo-copier, a facsimile machine, and a multi-functional product, receives image data of an image including pictures, photo, texts, etc., from a host machine, such as a computer system, and performs a printing operation based on the received image data on a printable medium, such as paper.

The printing apparatus performs a printing operation of an image to be printed on a printable medium such as paper, beginning with the left edge of the image as a reference. This is because an application program interface (API) of an operating system (OS) which is utilized by a printer driver of the host machine has characteristics that return a left edge-based object. For purposes of discussion, a printing location which serves as a reference during printing of an image such as the left edge or the right edge, is called a “printing reference.”

In the case that the size of an image to be printed is greater than the size of a printable medium, such as a sheet of paper, the parts which deviate from the size of the sheet of paper cannot be printed, unless the image is reduced. In this case, since only the parts of the image which is allowed by the width of the paper can be printed with the left edge of the image as a reference, the right side portion of the image is cut.

For example, as shown in FIG. 1, in the case that an image 1 containing content of a certain web page is to be printed on a printing paper 2, and the width of the image 1 is broader than the width of the printing paper 2, a part of the right side portion 1b of the image 1 is not printed since a printing operation is performed based on the left part 1a of the image 1.

In the case that the content that a user wants to print is at the right side portion 1b of the image 1, a desired printing result may not be obtained since that content may be cut out in the conventional printing apparatus. Specifically, when an image 1 is a normal web page, the formatting content is arranged in a left part 1a of the image 1 and the substantial content is arranged in a right side portion 1b. Contents that a user tries to print are frequently contained in the right side portion 1b of the image 1.

However, there is a problem that a part of the image which is bigger than the size of the printing paper 2 cannot be printed on the printing paper 2, if a printing location is fixed based on a particular segment of an image including, for example, the left edge 1a of the image 1. That is, some parts of an image a user wants to print are not able to be printed on a printing paper.

### SUMMARY OF THE INVENTION

Several aspects and example embodiments of the present invention provide a printing apparatus, a printing system, and a printing method which can enable a user to properly print the part of an image which s/he wishes to print, by altering a printing reference of the image.

Additional aspects and/or advantages of the invention will be set forth in part in the description which follows and, in part, will be obvious from the description, or may be learned by practice of the invention.

In accordance with an example embodiment of the present invention, there is provided a printing apparatus comprising: a communications unit which communicates with a host machine; a printing unit which prints an image on a printable medium such as a printing paper; and a control unit which alters a printing reference for an image with respect to a printing paper using size information of the image to be printed, and size information of the printing paper on which the image is printed.

According to an aspect of the present invention, the size information of the image and the size information of the printing paper comprise information representing the width of the image and the width of the printing paper, respectively.

According to an aspect of the present invention, the control unit controls alteration of the printing reference into a right edge of the image.

According to another aspect of the present invention, the control unit controls the printing unit to perform a printing of the image to be included on the printing paper.

According to an aspect of the present invention, at least one of the size information of the image and the size information of the printing paper is received from the host machine.

In accordance with another example embodiment of the present invention, there is provided a printing system comprising: a host machine which transmits size information of an image to be printed and size information of a printing paper on which the image will be printed; and a printing apparatus which alters a printing reference for the image with respect to the printing paper using the size information of the image and the size information of the printing paper which are transmitted from the host machine.

According to an aspect of the present invention, the size information of the image and the size information of the printing paper comprise information representing the width of the image and the width of the paper, respectively.

According to an aspect of the present invention, the printing apparatus alters a printing reference into a right edge of the image.

According to an aspect of the present invention, the host machine represents a user interface (UI) for select a left edge or the right edge of the image as the printing reference.

According to an aspect of the present invention, the host machine transmits the size information of the image and the size information of the printing paper to the printing apparatus in the case that the right edge is selected.

According to an aspect of the present invention, the printing apparatus performs a printing of the image included in the printing paper.

In accordance with another example embodiment of the present invention, there is provided a printing method comprising: altering a printing reference for an image with respect to a printing paper using size information of the image to be printed and size information of a printing paper on which the image is printed; and printing the image according to an altered printing reference.

According to an aspect of the present invention, the size information of the image and the size information of the printing paper comprise information representing the width of the image and the width of the printing paper, respectively.

According to an aspect of the present invention, the altering the printing reference comprises altering the printing reference into the right edge of the image.

According to an aspect of the present invention, the printing the image comprises printing the image included in the printing paper.

According to an aspect of the present invention, the printing method further comprises: selecting the left edge or the right edge as the printing reference.

According to another aspect of the present invention, the altering of the printing reference is performed in the case that the right edge is selected.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 shows an example of an image to be printed on a printable medium;

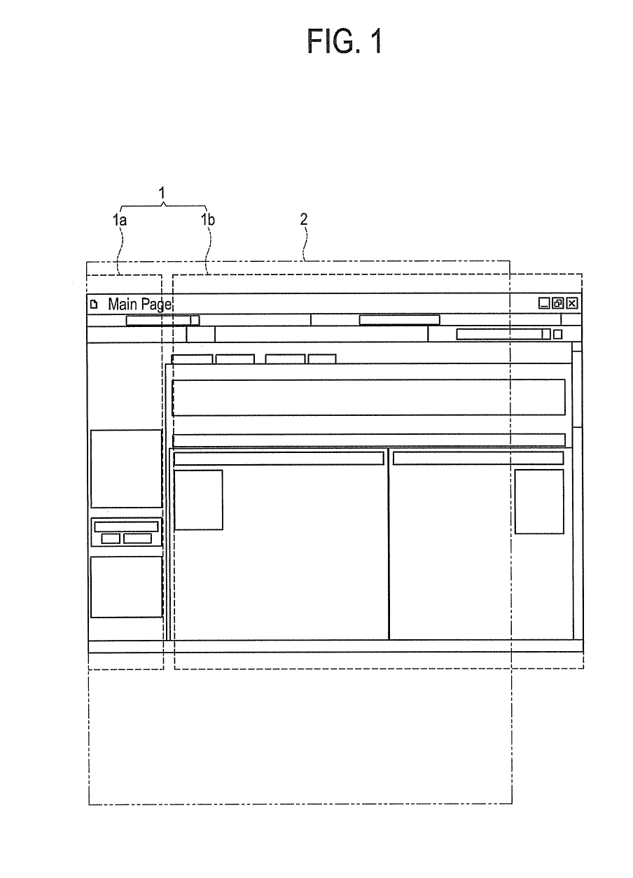

FIG. 2 is a block diagram showing a configuration of a printing system according to an example embodiment of the present invention;

FIG. 3 shows an example of an image to be printed on a printable medium by a printing system according to an example embodiment of the present invention;

FIG. 4 shows an user interface (UI) indicated by a printing system according to an example embodiment of the present invention; and

FIG. 5 is a flowchart view illustrating a printing method according to an example embodiment of the present invention.

### DETAILED DESCRIPTION OF THE EXAMPLE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

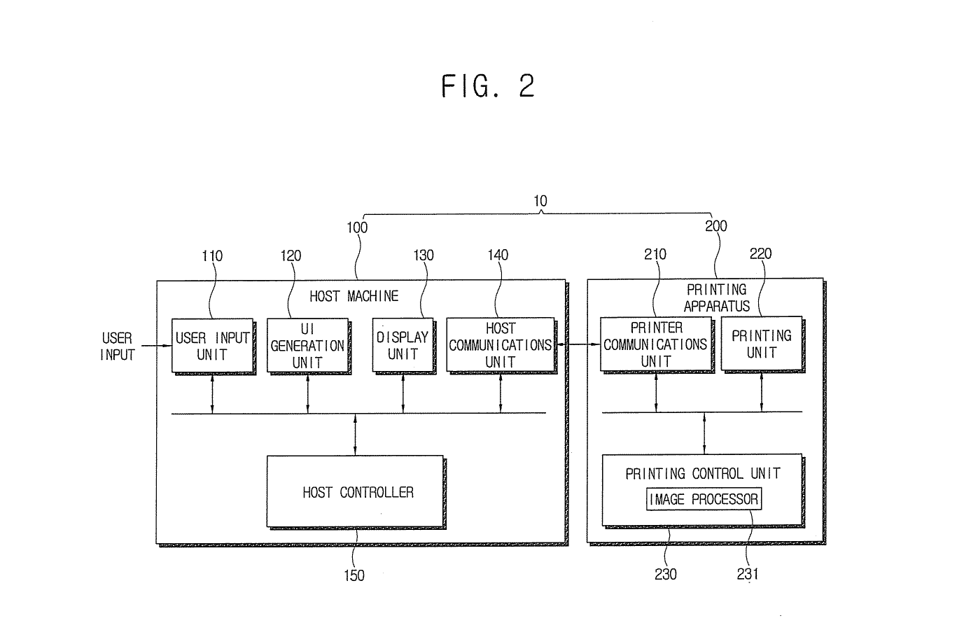

FIG. 2 is a block diagram showing a configuration of a printing system 10 according to an example embodiment of the present invention. As shown in FIG. 2, the printing system 10 includes a host machine 100 and a printing apparatus 200.

The host machine 100 provides image data of an image including, for example, pictures, photos, and text, to the printing apparatus 200, and controls operation of the printing apparatus 200. The host machine 100 can be a computer system, such as a personal computer (PC). As shown in FIG. 2, the host machine 100 includes a user input unit 110, a UI (user interface) generating unit 120, a display unit 130, a host communications unit 140, and a host controller 150.

The user input unit 110 receives a printing instruction from a user and delivers the printing instruction to the host controller 150. The user input unit 110 can be a keyboard, or a cursor control device, such as a mouse, track ball, touch pad, joystick, etc.

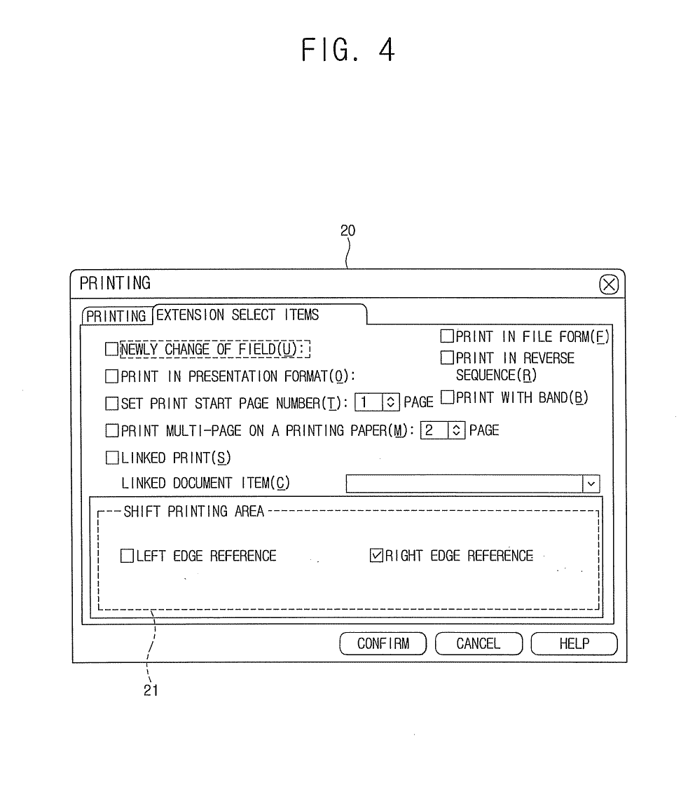

The UI generating unit 120 produces a user interface (UI) 20, as shown, for example, in FIG. 4, which is indicated on the display unit 130 under the control of the host controller 150. According to an example embodiment of the present invention, the user interface (UI) 20 provides a visual display of a shift printing area section 21 which contains icons such as a left edge reference icon and a right edge reference icon to enable a user to select any one of the left edge and the right edge of an image as a printing reference. In addition, the user interface (UI) 20 also provides a visual display of printing function/select items for an ordinary printing, such as an icon regarding a newly change of field, an icon regarding a print in presentation format, an icon regarding a set print start page number, an icon regarding a print multi-page on a printing paper, an icon regarding linked print(s) and linked document item(s), an icon regarding print in file form, an icon regarding print in reverse sequence, and an icon regarding print with band.

The display unit 130 displays the user interface (UI) generated by the UI generating unit 120, and can be a cathode ray tube (CRT) monitor, a liquid crystal display (LCD) monitor, or a plasma display panel (PDP) monitor.

The host communications unit 140 communicates with the printing apparatus 200 under the control of the host controller 150. The host communications unit 140 can be implemented with a network interface card, etc.

The host controller 150 controls the host machine 100 as a whole. The host controller 150 transmits the image data of an image to be printed on a printing paper to the printing apparatus 200, if a printing request is inputted from a user.

When the host controller 150 transmits image data, size information of the image and size information of a printing paper on which the image will be printed are transmitted together with the image data to the printing apparatus 200. The size information of the image and the size information of the paper in this example embodiment of the present invention, include information representing the width of the image and the width of the printing paper, respectively. The width of the image and the width of the paper can be represented in units of dots.

The host controller 150 controls the UI generating unit 120, in order to provide a user interface (UI) 20, as shown in FIG. 4, which enables a user to select the left edge or right edge of an image as a printing reference. According to an example embodiment of the present invention, the host controller 150 transmits the size information of the image and the size information of the printing paper to the printing apparatus 200, in the case that the right edge is selected by a user as a printing reference. Moreover, the host controller 150 transmits horizontal location information representing a printing location in the horizontal direction of an image together with the image data, to the printing apparatus 200. The host controller 150 can use a predetermined printer language in transmitting the image data, the size information of the image, the size information of the paper, and horizontal location information representing the printing location. The host controller 150 can be implemented with what is called a computer program, such as a printer driver.

The printing apparatus 200 performs a printing on a printing paper based on the image data transmitted from the host machine 100 under the control of the host machine 100. As shown in FIG. 2, the printing apparatus 200 includes a printer communications unit 210, a printing unit 220, and a printer control unit 230.

The printer communications unit 210 communicates with the host communications unit 140 under the control of the printer control unit 230. The printer communications unit 210 corresponding to the communications type of the host communications unit 140 can be implemented as a network interface card, etc. The printer communications unit 210 is an example of the communications unit of the printing apparatus according to the present invention.

The printing unit 220 performs a printing based on image data under the control of the printer control unit 230. The printing unit 220 can perform a printing in the form of an ink-jet printing, a laser printing, etc.

The printer control unit 230 controls the printing apparatus 200 as a whole. The printer control unit 230 controls the printing unit 220 in order to perform printing of transmitted image data according to a printing instruction from the host machine 100. The printer control unit 230 is an example of the controller of the printing apparatus according to the present invention.

The printer control unit 230 according to this example embodiment of the present invention changes the printing reference of an image with respect to a printing paper using the size information of the image transmitted with the host machine 100 and the size information of the printing paper on which the image will be printed. Specifically, the printer control unit 230 shifts the printing reference to the left by a difference between the widths of an image to be printed and a printing paper on which the image is printed, when the right edge is selected as the printing reference.

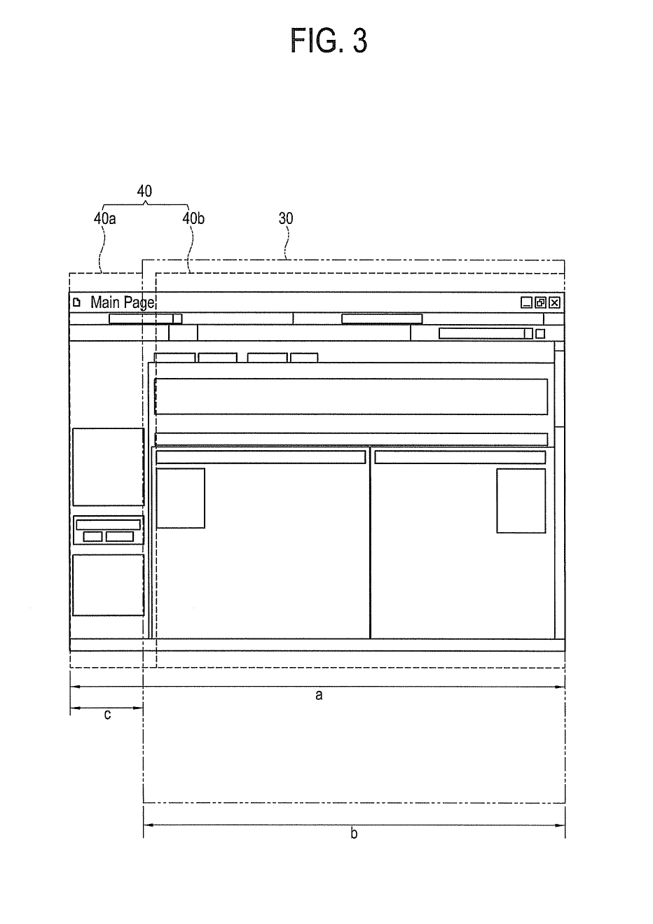

For example, as shown in FIG. 3, assuming that the width of an image 40 is “a” and the width of a printing paper 30 is “b,” the printer control unit 230 shifts the printing reference of an image 40 to the left by “c” which is a difference between “a” the width of the image 40 to be printed and “b” the width of the printing paper 30 on which the image is printed. That is, the printing reference is changed so that the right edge of the image 40 can be aligned to the right side of the printing paper 30. The printer control unit 230 can include an image processor 231 for the image processing necessary to shift the printing reference. The printer control unit 230 can be implemented with a computer program such as a printer firmware.

The printer control unit 230 performs a parsing operation on transmitted data from the host machine 100 in a predetermined printer language form and obtains the width of an image, the width of a printing paper, a horizontal position value, etc. The printer control unit 230 obtains a difference between the obtained width of the image and the obtained width of the paper, and thus determines a left edge value adjusted to change the printing reference. The printer control unit 230 subtracts the determined left edge value from the existing horizontal position value of the image to be printed, and thus determines a new horizontal position value. The printing unit 220 performs a printing of the image based on the new horizontal position value.

In the case that a horizontal position value of an image to be printed is greater than the adjusted left edge value, the printing control unit 230 performs a decoding on image data of a corresponding image and produces resulting image data in the form of a bitmap. In this example embodiment of the present invention, the printing unit 220 performs a printing based on the resulting image data. Therefore, a printing is performed for only the image included in the printing paper from the image whose printing reference has been altered (see a reference numeral 40b of FIG. 3).

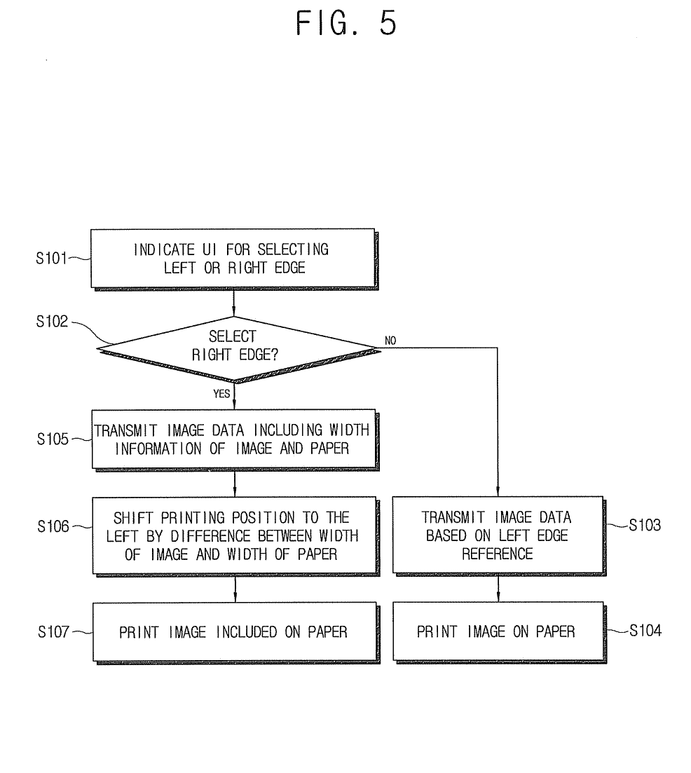

FIG. 5 is a flowchart illustrating a printing method according to an example embodiment of the present invention. As shown in FIG. 5, the host machine 100 indicates a user interface (UI) for enabling a user to select a left edge or a right edge of an image, as shown in FIG. 4, as a printing reference at block S101. When the left edge is selected by a user, the host machine 100 transmits image data based on the left edge to the printing apparatus 200 at block S103. The printing apparatus 200 performs a printing based on the transmitted image data on a printing paper 30, as shown in FIG. 3, at block S104. The processes at block S103 and block S104 are similar to the conventional printing processes.

However, if the right edge is selected by a user at block S102, the host machine 100 transmits information representing a difference between the width of the image and the width of the printing paper 30 together with the image data, to the printing apparatus 200 at block S105. Then, the printing apparatus 200 shifts the printing reference for the image to the left by the difference between the width of the image and the width of the printing paper at block S106. Then, the printing apparatus 200 performs a printing for the image included on the printing paper (S107).

As described above, according to the present invention, the printing reference for an image may be changed. Accordingly, the part of the image which a user wants to print can be properly printed on the paper. Particularly, in the case of printing an image such as a web page, the image can be printed based on the right edge as the printing reference, according to the present invention. Therefore, the right side portion of the image ordinarily containing contents which a user wants can be printed without having right side portions cut.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the printing basis has been described with respect to the case of the right edge but is not restricted thereto. In addition, the user interface can also be incorporated into the printing apparatus 200, as shown in FIG. 2 to enable a user to alter a printing reference for an image directly on the printable apparatus 200, without the need of a host machine 100. Moreover, various components of the host machine 100, as shown in FIG. 2, can be integrated into a single control unit, or alternatively, can be implemented in software or hardware, such as, for example, a field programmable gate array (FPGA) and an application specific integrated circuit (ASIC). As such, it is intended that the processes described herein be broadly interpreted as being equivalently performed by software, hardware, or a combination thereof. Software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A printing apparatus comprising:
a communications unit arranged to communicate with a host machine;
a printing unit to print an image on a printable medium; and
a control unit arranged to alter a printing reference for an image with respect to the printable medium using size information of the image to be printed on the printable medium, and size information of the printable medium on which the image is printed.

2. The printing apparatus according to claim 1, wherein the size information of the image and the size information of the printable medium comprise information representing the width of the image and the width of the printable medium, respectively.

3. The printing apparatus according to claim 1, wherein the control unit controls alteration of the printing reference into a right edge of the image.

4. The printing apparatus according to claim 1, wherein the control unit controls the printing unit to print the image on the printable medium.

5. The printing apparatus according to claim 1, wherein at least one of the size information of the image and the size information of the printable medium is received from the host machine.

6. A printing system comprising:
a host machine arranged to transmit size information of an image to be printed on a printable medium and size information of the printable medium on which the image is to be printed; and
a printing apparatus arranged to alter a printing reference for the image with respect to the printable medium using the size information of the image and the size information of the printable medium which are transmitted from the host machine.

7. The printing system according to claim 6, wherein the size information of the image and the size information of the printable medium comprise information representing the width of the image and the width of the printable medium, respectively.

8. The printing system according to claim 6, wherein the printing apparatus alters a printing reference into a right edge of the image.

9. The printing system according to claim 6, wherein the host machine represents a user interface (UI) for select a left edge or the right edge of the image as the printing reference.

10. The printing system according to claim 9, wherein the host machine transmits the size information of the image and the size information of the printable medium to the printing apparatus in the case that the right edge is selected.

11. The printing system according to claim 6, wherein the printing apparatus performs a printing of the image included on the printable medium.

12. A printing method comprising:
altering a printing reference for an image with respect to a printable medium using size information of the image to be printed and size information of a printable medium on which the image is printed; and
printing the image according to an altered printing reference.

13. The printing method according to claim 12, wherein the size information of the image and the size information of the printable medium comprise information representing the width of the image and the width of the printable medium, respectively.

14. The printing method according to claim 12, wherein the altering the printing reference comprises altering the printing reference into the right edge of the image.

15. The printing method according to claim 12, further comprising:
selecting the left edge or the right edge as the printing reference.

16. The printing method according to claim 15, wherein the altering the printing reference is performed in the case that the right edge is selected.

17. A printing apparatus comprising:
a printing unit arranged to print an image on a printable medium; and
a control unit arranged to receive size information of an image to be printed on the printable medium and size information of the printable medium, and to alter a printing reference for the image with respect to the printable medium using the size information of the image and the size information of the printable medium.

18. The printing apparatus according to claim 17, wherein the size information of the image and the size information of the printable medium comprise information representing the width of the image and the width of the printable medium, respectively.

19. The printing apparatus according to claim 17, wherein the control unit alters a printing reference into a right edge of the image.

20. The printing apparatus according to claim 17, further comprising a user interface (UI) provided to enable a user to select a left edge or the right edge of the image as the printing reference.
